(19) United States
(12) Patent Application Publication
(10) Pub. No.: US 2007/0177521 A1
(43) Pub. Date: Aug. 2, 2007

(54) Method for detecting communication condition, communication condition detecting system, and communication condition detecting apparatus

(75) Inventors: Noriyuki Fukuyama, Kawasaki (JP); Masanobu Morinaga, Kawasaki (JP); Hideaki Miyazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/497,296

(22) Filed: Aug. 2, 2006

(30) Foreign Application Priority Data
Jan. 30, 2006 (JP) 2006-021474

(51) Int. Cl. H04J 1/16

(52) U.S. Cl. 370/252; 370/389

(57) ABSTRACT

To detect the communication conditions of a communication path set in a packet network such as a VoIP network, a detection packet is periodically transmitted to the communication path and a load packet is transmitted to the communication path. Then, the time and loss conditions regarding a detection packet having passed through the communication path are detected, and changes in delay and jitter conditions and changes in loss rate according to a traffic load are grasped. Changes in the communication conditions of the communication path at high load can be detected while minimizing the occurrence of adverse effects on other communications.

### CROSS-REFERENCE TO RELATED APPLICATIONS

This Nonprovisional application claims priority under 35 U.S.C. §119(a) on Patent Application No. 2006-21474 filed in Japan on Jan. 30, 2006, the entire contents of which are hereby incorporated by reference.

### BACKGROUND OF THE INVENTION

1. Field of the Invention

The present invention relates to a method for detecting communication condition that detects the communication conditions of a communication path set in a packet network such as a VoIP network. Particularly, the present invention relates to a method for detecting communication condition that detects communication conditions by generating a temporary high-load condition in a communication path. In addition, the present invention relates to a communication condition detecting system to which the aforementioned method is applied and a communication condition detecting apparatus for use in such a detecting system.

2. Description of Related Art

A communication system such as an IP phone which uses a packet network such as a VoIP (Voice over IP) network has become widespread. In order to maintain the communication quality (QoS: Quality of Service) of a packet network such as a VoIP network, it is important to grasp in advance the communication conditions for the case in which the traffic load increases. For example, by grasping in advance communication conditions for various traffic loads as basic data and checking the communication conditions of, for example, a VoIP communication performed between users, against the basic data, a sign of degradation of communication quality is found and thereby quality degradation can be predicted.

For a method of grasping communication condition which are used as basic data, Japanese Patent Application Laid-Open No. 2005-184471 discloses a method in which, while the load on an information processing device is changed variously, the reaction of the information processing device is measured through a packet communication network.

However, when an applied version of the method of measuring the condition of a communication device which is disclosed in Japanese Patent Application Laid-Open No. 2005-184471 is used to measure the communication conditions of a communication path (link) set in a packet network, specifically, when the communication conditions of a communication path are measured by using a load on a communication device, which is described in Japanese Patent Application Laid-Open No. 2005-184471, as a load on the communication path and changing the load on the communication path variously, various inconveniences arise such as those described below.

Since the method described in Japanese Patent Application Laid-Open No. 2005-184471 is to apply a processing load to an information processing device, other communication devices, communication paths, or communication networks are not adversely affected, and thus the method itself is an excellent method. However, when the method is applied as a method of applying a traffic load to a communication path, it is highly possible that other communications may be adversely affected such as communication failure in communication service being performed.

### BRIEF SUMMARY OF THE INVENTION

The present invention is made in view of the foregoing and other problems. An object of the present invention is therefore to provide a method for detecting communication condition that is capable of detecting changes in the communication conditions of a communication path at high load while minimizing the occurrence of adverse effects on other communications, a communication condition detecting system to which the method for detecting communication condition is applied, and a communication condition detecting apparatus for use in the communication condition detecting system.

Frankly, the present invention adopts a configuration in which a detection packet with a low traffic load is periodically transmitted onto a communication path and a load packet that causes the traffic load to be temporarily increased is transmitted onto the communication path, whereby the communication condition of the communication path.

A method for detecting communication condition according to the present invention is a method for detecting communication condition of a communication path set in a packet network, and is characterized by comprising the steps of periodically transmitting from a transmitting apparatus to the communication path a detection packet used to detect a communication condition; transmitting from a transmitting apparatus to the communication path a load packet applying a traffic load to the communication path; and detecting, by a communication condition detecting apparatus, a communication condition of the communication path based on a time and loss condition related to the detection packet having passed through the communication path.

In the method according to the present invention, a detection packet with a low traffic load is periodically transmitted and a load packet that causes the traffic load to be temporarily increased is transmitted, whereby communication conditions such as the delay, jitter, and loss rate of a detection packet are detected. Upon this, since the traffic load applied to the communication path is temporarily present, changes in the communication conditions of the communication path at high load can be detected while minimizing the occurrence of adverse effects on other communication services being performed.

A communication condition detecting system of a first aspect according to the present invention is a communication condition detecting system for detecting, by a communication condition detecting apparatus, a communication condition of a communication path set in a packet network, including: a transmitting apparatus comprising: first transmitting means for periodically transmitting to the communication path a detection packet used to detect a communication condition; and second transmitting means for transmitting to the communication path a load packet for applying a traffic load to the communication path; wherein the communication condition detecting apparatus detects a communication condition of the communication path based on a time and loss condition related to the detection packet having passed through the communication path.

In the communication condition detecting system of the first aspect, a detection packet with a low traffic load is periodically transmitted and a load packet that causes the traffic load to be temporarily increased is transmitted, whereby the communication conditions of a detection packet are detected. Upon this, since the traffic load applied to the communication path is temporarily present, changes in the communication conditions of the communication path at high load can be detected while minimizing the occurrence of adverse effects on other communication services being performed.

A communication condition detecting system of a second aspect according to the present invention is, in the first aspect, characterized in that the second transmitting means transmits to the communication path, as a group of the load packets, a plurality of packets which are successively transmitted.

In the communication condition detecting system of the second aspect, by successively transmitting a plurality of packets, the traffic load is temporarily increased and thereby a high-load condition can be generated.

A communication condition detecting system of a third aspect according to the present invention is, in the second or third aspect, characterized in that the second transmitting means transmits to the communication path the load packet a plurality of times at a longer time interval than a transmission period of the detection packet transmitted from the first transmitting means.

In the communication condition detecting system of the third aspect, by transmitting a load packet at a longer time interval than the transmission period of the detection packet, conditions from where the transmission timing of the detection packet matches the transmission timing of the load packet to where the transmission timing of the detection packet does not match the transmission timing of the load packet can be generated. Accordingly, the communication conditions of a detection packet under various communication conditions can be detected.

A communication condition detecting system of a fourth aspect according to the present invention is, in any one of the first through third aspects, is characterized further including a load transmitting apparatus for transmitting a load packet to the communication path.

In the communication condition detecting system of the fourth aspect, load packets are transmitted from a transmitting apparatus and a single or a plurality of loading apparatuses. By this, even when such a transmitting apparatus is used that has a low capability to transmit a load packet to a communication path whose conditions are the object to be grasped, load packets can be transmitted to the communication path from a plurality of paths by using a plurality of apparatuses. Accordingly, a desired traffic load can be applied to the communication path. Moreover, traffic loads that are applied to paths other than the communication path whose conditions are the object to be grasped can be minimized.

A communication condition detecting system of a fifth aspect according to the present invention is such that in the fourth aspect is characterized in that the transmitting apparatus and the load transmitting apparatus make transmission timings of the load packets to the communication path be synchronized to each other.

In the communication condition detecting system of the fifth aspect, by allowing the transmission timings of load packets to be synchronized to each other, a high-load condition can be generated in the communication path.

A communication condition detecting system of a sixth aspect according to the present invention is, in the fourth aspect, characterized in that the transmitting apparatus and the load transmitting apparatus transmit to the communication path the load packets with different periods.

In the communication condition detecting system of the sixth aspect, by transmitting load packets with different periods, fluctuation in traffic load can be generated with a period based on the product of the transmission periods of the load packets and the difference between the transmission periods of the load packets.

A communication condition detecting system of a seventh aspect according to the present invention is a communication condition detecting system for detecting, by a communication condition detecting apparatus, a communication condition of a communication path set in a packet network, and is characterized by including: a transmitting apparatus for periodically transmitting a detection packet to the communication path; and a load transmitting apparatus for transmitting a load packet to the communication path; wherein the communication condition detecting apparatus detects a communication condition of the communication path based on a time and loss condition related to the detection packet having passed through the communication path.

In the communication condition detecting system of the seventh aspect, a detection packet with a low traffic load is periodically transmitted and a load packet that causes the traffic load to be temporarily increased is transmitted, whereby the communication conditions of a detection packet are detected. Upon this, since the traffic load applied to the communication path is temporarily present, changes in the communication conditions of the communication path at high load can be detected while minimizing the occurrence of adverse effects on other communication services being performed.

A communication condition detecting apparatus according to the present invention is characterized by using in the communication condition detecting system according to any one of the first through seventh aspects.

In the communication condition detecting apparatus according to the present invention, a detection packet with a low traffic load is periodically transmitted and a load packet that causes the traffic load to be temporarily increased is transmitted, whereby the communication conditions of a detection packet are detected.

Upon this, since the traffic load applied to the communication path is temporarily present, changes in the communication conditions of the communication path at high load can be detected while minimizing the occurrence of adverse effects on other communication services being performed.

In the above-described method, communication condition detecting system, and communication condition detecting apparatus according to the present invention, to detect the communication conditions of a communication path set in a packet network such as a VoIP network, a detection packet is periodically transmitted to the communication path and a load packet is transmitted to the communication path. Then, the times and loss conditions regarding detection packets having passed through the communication path are detected, and changes in delay and jitter conditions and changes in loss rate according to a traffic load are grasped.

By this configuration, the present invention provides excellent effects; for example, because the traffic load applied to the communication path is temporarily present, changes in the communication conditions of the communication path at high load can be detected while minimizing the occurrence of adverse effects on other communication services being performed.

The grasped changes in the communication conditions of the communication path are totaled as the changes in the delay time, jitter, and loss rate of the detection packets and recorded as basic data. Then, by comparing, while communication service is actually being performed, the delay time, jitter, and loss rate of a packet with the basic data, the communication conditions can be grasped. As such, excellent effects are provided.

For example, by providing, while IP phone service is actually being performed, a temporary traffic load by transmitting a load packet, a pseudo higher load condition than the actual load condition can be generated without significantly affecting the IP phone service. By comparing the high-load condition with the basic data, the level of load can be grasped. As such, excellent effects are provided.

Specifically, by temporarily transmitting load packets that correspond to a traffic load of 10 calls to a communication path on which IP phone service of 20 calls is performed, the communication conditions for the case in which 30 calls are made are grasped and it is possible to judge how many more calls are acceptable.

In addition, in the present invention, by transmitting load packets from a plurality of apparatuses, even when such a transmitting apparatus is used that has a low capability to transmit a load packet to a communication path whose conditions are the object to be grasped, load packets can be transmitted to the communication path from a plurality of paths by using a plurality of apparatuses. Accordingly, excellent effects are provided such as the capability to apply a desired traffic load to the communication path. Moreover, excellent effects are provided such as the capability to minimize traffic loads that are applied to paths other than the communication path whose conditions are the object to be grasped.

Furthermore, the present invention provides excellent effects; for example, by transmitting load packets from a plurality of apparatuses with different periods, fluctuation in traffic load can be generated with a period based on the difference between the transmission periods of the load packets.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram conceptually showing a configuration of a communication condition detecting system according to Embodiment 1 of the present invention;

FIG. 2 is a schematic diagram conceptually showing the change in time of packets passing through a communication path in the communication condition detecting system according to Embodiment 1 of the present invention;

FIG. 3 is a block diagram showing a configuration of various apparatuses used in the communication condition detecting system according to Embodiment 1 of the present invention;

FIG. 4 is a graph showing basic data on communication conditions detected by the communication condition detecting system according to Embodiment 1 of the present invention;

FIG. 5 is a graph showing basic data on the communication conditions detected by the communication condition detecting system according to Embodiment 1 of the present invention;

FIG. 6 is a schematic diagram conceptually showing a configuration of a communication condition detecting system according to Embodiment 2 of the present invention;

FIG. 7 is a block diagram showing a configuration of various apparatuses used in the communication condition detecting system according to Embodiment 2 of the present invention;

FIG. 8 is a schematic diagram conceptually showing a configuration of a communication condition detecting system according to Embodiment 3 of the present invention;

FIG. 9 is a schematic diagram conceptually showing a configuration of a communication condition detecting system according to Embodiment 4 of the present invention;

FIG. 10 is a schematic diagram conceptually showing the change in time of packets passing through a communication path in the communication condition detecting system according to Embodiment 4 of the present invention; and

FIG. 11 is a schematic diagram conceptually showing the change in time of a traffic load on the communication path in the communication condition detecting system according to Embodiment 4 of the present invention.

### DETAILED DESCRIPTION OF THE PRESENT INVENTION

The present invention will be described in detail below with reference to the drawings showing several embodiments of the invention.

### Embodiment 1

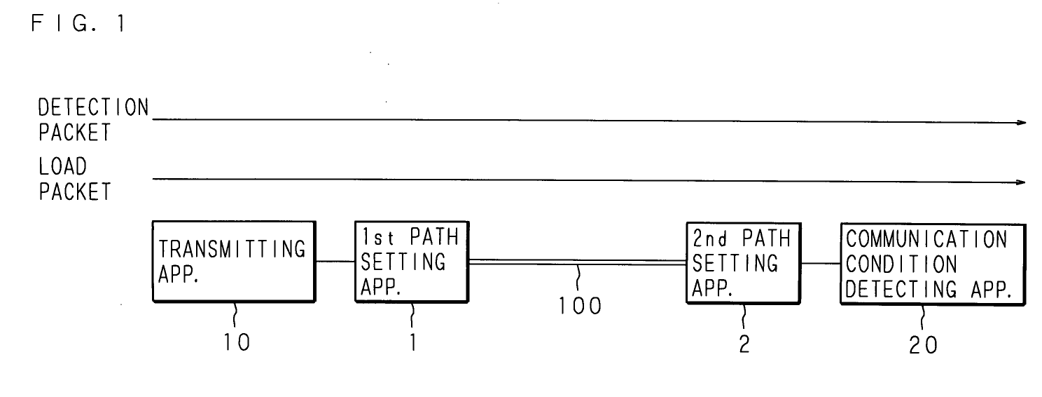

FIG. 1 is a schematic diagram conceptually showing the configuration of a communication condition detecting system according to Embodiment 1 of the present invention.

In FIG. 1, reference numeral 100 denotes a communication path (link) whose communication conditions are the object to be detected. Specifically, the communication path 100 is a communication path set in a packet network such as the Internet or a VoIP (Voice over IP) network. The communication path 100 is set by a first path setting apparatus 1 and a second path setting apparatus 2, both of which are routers or the like provided in the packet network. A transmitting apparatus 10 which uses a communication computer for transmitting packets is connected to the first path setting apparatus 1. A communication condition detecting apparatus 20 which uses a communication computer is connected to the second path setting apparatus 2. The transmitting apparatus 10 transmits packets to the communication path 100 through the first path setting apparatus 1. The communication condition detecting apparatus 20 obtains from the communication path 100 packets having passed through the second path setting apparatus 2 and detects the communication conditions of the communication path 100 based on the obtained packets.

The transmitting apparatus 10 transmits to the communication path 100 a detection packet to be used at the communication condition detecting apparatus 20 to detect communication conditions and a load packet used to apply a traffic load to the communication path 100. The transmitting apparatus 10 intermittently transmits a detection packet, for example, at a frequency which approximately corresponds to that for a single normal IP phone, specifically, with a period of 20 ms (milliseconds).

Also, the transmitting apparatus 10 transmits a load packet having high-load of 10 Mbps, for example, with a longer transmission period than the transmission period of the detection packet, e.g., a transmission period of one second. Note that a load packet having high-load can be generated as a large-size packet. In this case, for example, a group of load packets may be used that apply a high traffic load to the communication path 100 by successively transmitting 20 packets of 1.25 Kbytes in size per millisecond.

The communication condition detecting apparatus 20 obtains packet data of a detection packet having passed through the communication path 100. By this, the communication condition detecting apparatus 20 can detect communication conditions such as the delay time, jitter, loss rate, etc., of the detection packet, based on header information contained in the packet data, such as a transmission time and a sequence number. The detected communication conditions can be used as basic data for analysis of a prediction on degradation of the communication quality of the communication path 100.

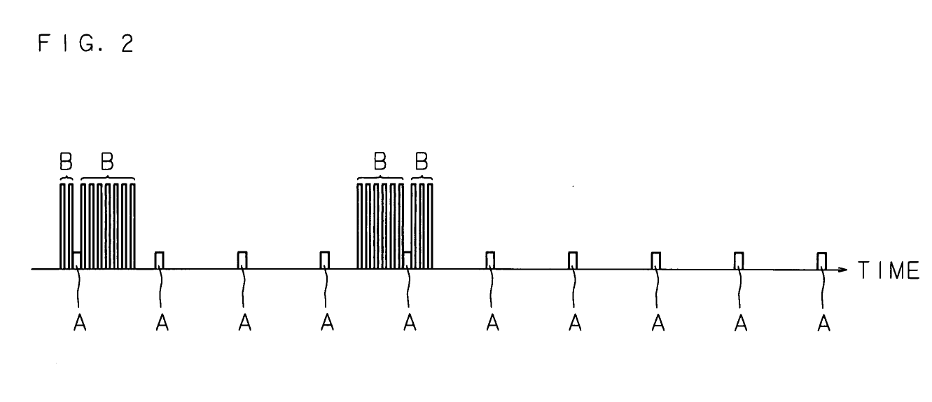

FIG. 2 is a schematic diagram conceptually showing the change in time of packets passing through the communication path 100 in the communication condition detecting system according to Embodiment 1 of the present invention.

In FIG. 2, reference symbol A denotes a detection packet. A detection packet is intermittently transmitted from the transmitting apparatus 10 with a period of 20 ms, for example. In FIG. 2, reference symbol B denotes a load packet. For a load packet, a plurality of packets are transmitted, as a group of load packets, from the transmitting apparatus 10 with a longer transmission period than the transmission period of the detection packet, e.g., a transmission period of one second.

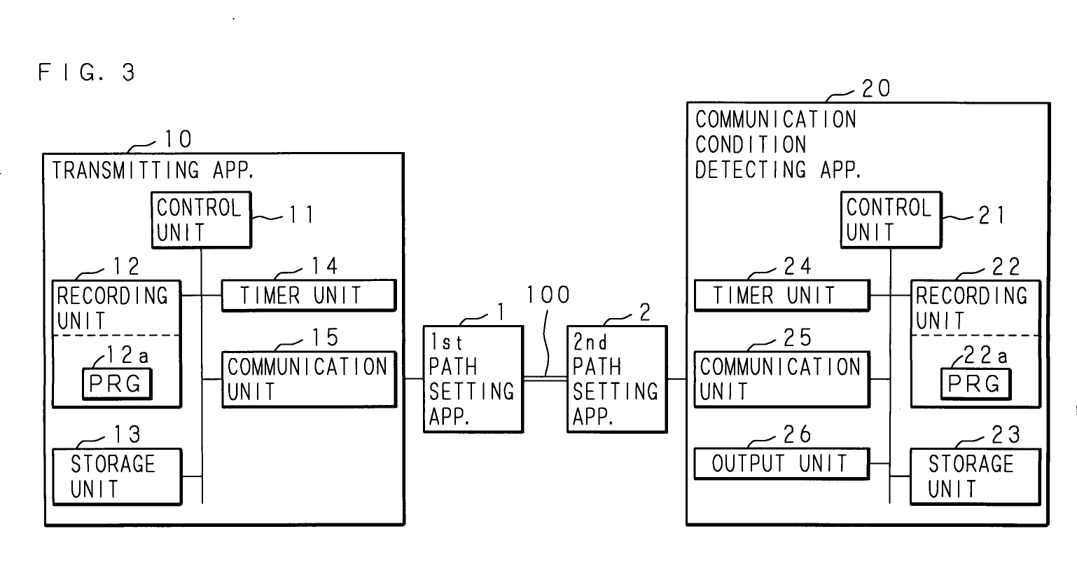

FIG. 3 is a block diagram showing the configuration of various apparatuses used in the communication condition detecting system according to Embodiment 1 of the present invention.

The transmitting apparatus 10 includes a control unit 11, such as a CPU, for controlling the entire apparatus; a recording unit 12, such as a hard disk, for recording various information such as a computer program (PRG) 12a for the transmitting apparatus and data; a storage unit 13, such as a RAM, for temporarily storing various information; a timer unit 14 which operates as a clock and a timer; and a communication unit 15 for sending out a packet onto the communication path 100.

The recording unit 12 and/or the storage unit 13 records and/or stores therein various data necessary to transmit a transmit packet and a load packet, such as an IP address (port number) of the communication condition detecting apparatus 20 which is specified as the destination of the packets, setting values for setting the attributes of the packets, the transmission periods of the packets, and the number of transmissions of packet. Note that the attribute of a packet includes information required to generate the packet, such as a packet size, packet protocols, such as a TCP (Transmission Control Protocol), a UDP (User Datagram Protocol), and an ICMP (Internet Control Message Protocol), a packet priority, such as a ToS (Type of Service) field value, and a sequence number assigned to the packet.

The communication condition detecting apparatus 20 includes a control unit 21; a recording unit 22 for recording various information such as a computer program (PRG) 22a for the communication condition detecting apparatus and data; a storage unit 23; a timer unit 24; a communication unit 25 for obtaining a packet having passed through the communication path 100; and an output unit 26 such as a monitor.

The recording unit 22 and/or the storage unit 23 records therein various information such as the transmission period of a detection packet transmitted from the transmitting apparatus 10 and also various information such as the time at which a detection packet is obtained and the sequence number of the obtained detection packet. Based on the recorded various information such as the time at which a detection packet is obtained and the sequence number of the detection packet, the communication condition detecting apparatus 20 derives a total value that indicates communication conditions such as the delay time and loss rate of the detection packet. For example, the communication condition detecting apparatus 20 compares an obtaining interval calculated from the difference between the times at which a plurality of detection packets are obtained, with the transmission period from the transmitting apparatus 10 and can thereby derive the jitter of the detection packets. In addition, the communication condition detecting apparatus 20 can derive, based on the missing condition of the sequence number of obtained detection packets, the loss rate of the detection packets. The transmission period may be recorded in advance in the communication condition detecting apparatus 20. Alternatively, a transmission time may be provided in a detection packet and the transmission period may be obtained from the transmission time.

As described using FIG. 1 to FIG. 3, the communication condition detecting system of the present invention periodically transmits the detection packet to the communication path 100 and transmits the load packet to the communication path 100 so as to generate a temporary high-load condition. Based on the detection packet obtained in an arbitrary load condition which is generated by the load packet, the communication condition detecting system of the present invention derives the communication conditions of the communication path 100 in the arbitrary load condition. The derived communication conditions are recorded as basic data in the recording unit 22 and outputted from the output unit 26. In addition, the communication condition detecting system of the present invention detects the communication conditions of the communication path 100 in communication service being performed such as IP phone service, based on an obtained detection packet. The communication condition detecting system of the present invention compares the detected communication conditions with the recorded basic data and thereby predicts changes in communication conditions, in particular, the possibility of degradation of communication quality.

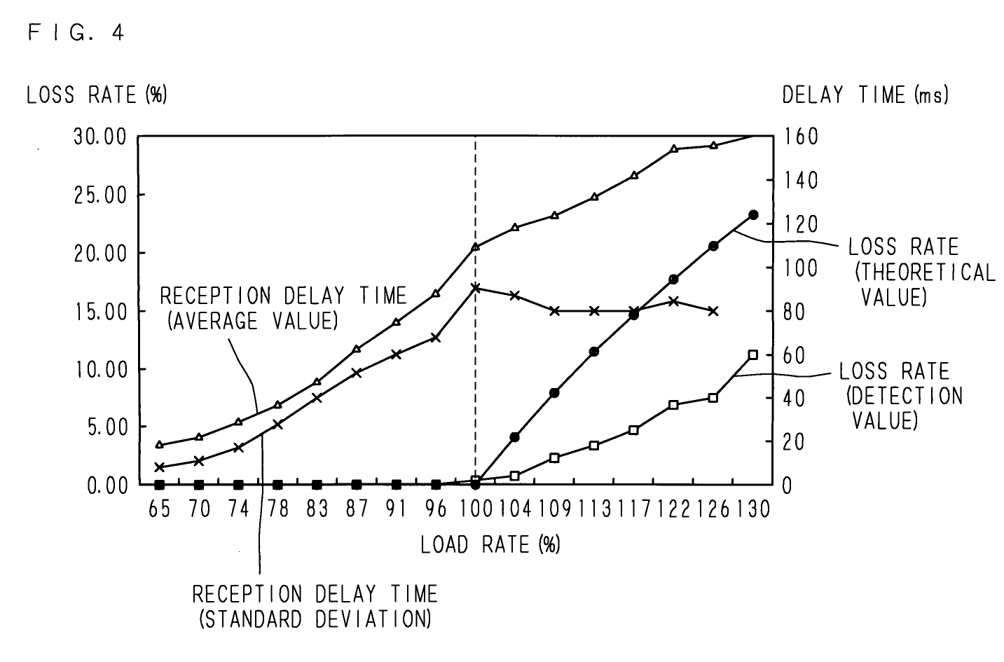

Now, basic data on the communication conditions of the communication path 100 which are derived based on an obtained detection packet obtained by the communication condition detecting apparatus 20 will be described. FIG. 4 is a graph showing basic data on communication conditions detected by the communication condition detecting system according to Embodiment 1 of the present invention.

For a jitter, in the following description, a single detection packet is selected as a reference, the times at which other detection packets should be received are calculated based on the reception time and transmission period of the selected detection packet, and the degree of “time lag” between the times when the other detection packets are actually received and the times when the other detection packets should be received is expressed as the “reception delay”. Furthermore, the following description employs, as an example, the case in which the detection packet having the lowest reception delay value is selected as the reference detection packet. FIG. 4 is a graph showing the relationship between a reception delay time (ms) and a loss rate (%) relative to a load rate (%) of the communication path 100. For the reception delay time, its average value and standard deviation are shown. For the loss rate, its theoretical value and detection value are shown. Note that the load rate is calculated based on the relationship between the transfer capability of the communication path 100 and the amount of data of a load packet sent out to the communication path 100.

As shown in FIG. 4, the reception delay time has an increase trend in both the average value and the standard deviation from when the load rate of the communication path 100 is on the order of 60%. However, once the load rate is increased to the order of 100%, the standard deviation becomes constant. On the other hand, the average value continues to increase even after the load rate exceeds 100%. The loss rate in both the theoretical value and the detection value increases with a substantially constant trend, after the load rate exceeds 100%.

By checking against the basic data shown in FIG. 4, the communication conditions of the communication path 100 in communication service being performed can be detected. For example, when it is detected that the reception delay time has begun to increase, it can be judged that the load rate of the communication path exceeds about 60%. When it is detected that the average value of the reception delay time is 50 ms, for example, it can be judged that the load rate of the communication path 100 is about 80%. When it is detected that both the average value and standard deviation of the reception delay time show an increase trend, it is judged that the load rate of the communication path 100 is on the order of 60% to 90%. When it is detected that, while the average value of the reception delay time shows an increase trend, the standard deviation of the reception delay time is constant, or when loss has begun to be observed, it is judged that the load rate of the communication path 100 exceeds 100%.

Note that the graph of basic data shown in FIG. 4 varies depending on various factors such as the models of the first path setting apparatus 1 and the second path setting apparatus 2 and the type of communication service provided using the communication path 100. However, since the communication condition detecting system of the present invention can detect communication conditions while communication service is actually being performed, basic data that supports the communication service actually being performed can be obtained.

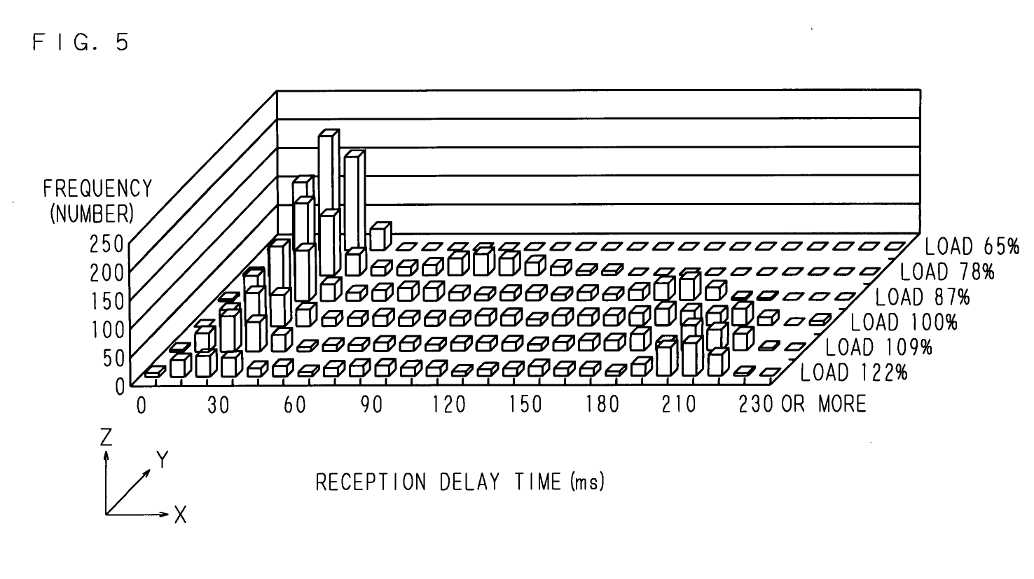

FIG. 5 is a graph showing basic data on communication conditions detected by the communication condition detecting system according to Embodiment 1 of the present invention.

In FIG. 5, the reception delay time (ms), the load rate (%), and the frequency of packets (the number of packets) are taken in an X-axis direction, a Y-axis direction, and a Z-axis direction, respectively, whereby the relationship therebetween is shown.

That is, from FIG. 4, how the distribution of the reception delay time changes according to the load rate can be grasped. Note that the detection packet is transmitted with a transmission period of 20 ms, i.e., a frequency of 500 packets/10 seconds.

As shown in FIG. 5, when the load rate is 65%, the reception delay time is concentrated in the neighborhood of 20 ms. Namely, it can be considered that the reception delay time in the neighborhood of 20 ms is a steady delay in the communication path 100. When the load rate exceeds 100%, in addition to the steady reception delay whose peak is in the neighborhood of 20 ms, a serious reception delay whose peak is in the neighborhood of 200 ms occurs. When the load rate is 78%, packet arrival with a reception delay time in the neighborhood of 100 ms is observed. This can be considered to be a distribution change which occurs in transition before a serious delay occurs. Accordingly, when the number of packets with a delay time in the neighborhood of 100 ms has begun to increase, it can be judged that it is a sign of degradation of communication conditions and thus measures such as communication control can be taken.

Although the above Embodiment 1 describes the configuration in which the transmitting apparatus transmits the load packet with a longer transmission period than the transmission period of the detection packet, the present invention can be developed into various configurations, e.g., the load packet does not necessarily need to be transmitted periodically.

### Embodiment 2

Embodiment 2 provides a configuration in which in Embodiment 1 a load transmitting apparatus for transmitting a load packet is provided in addition to a transmitting apparatus for transmitting a detection packet, and a load receiving apparatus for receiving the load packet is provided in addition to a communication condition detecting apparatus. Note that in the following description the components identical to those in Embodiment 1 are denoted by the same reference numerals as those used for Embodiment 1 and the description thereof is omitted.

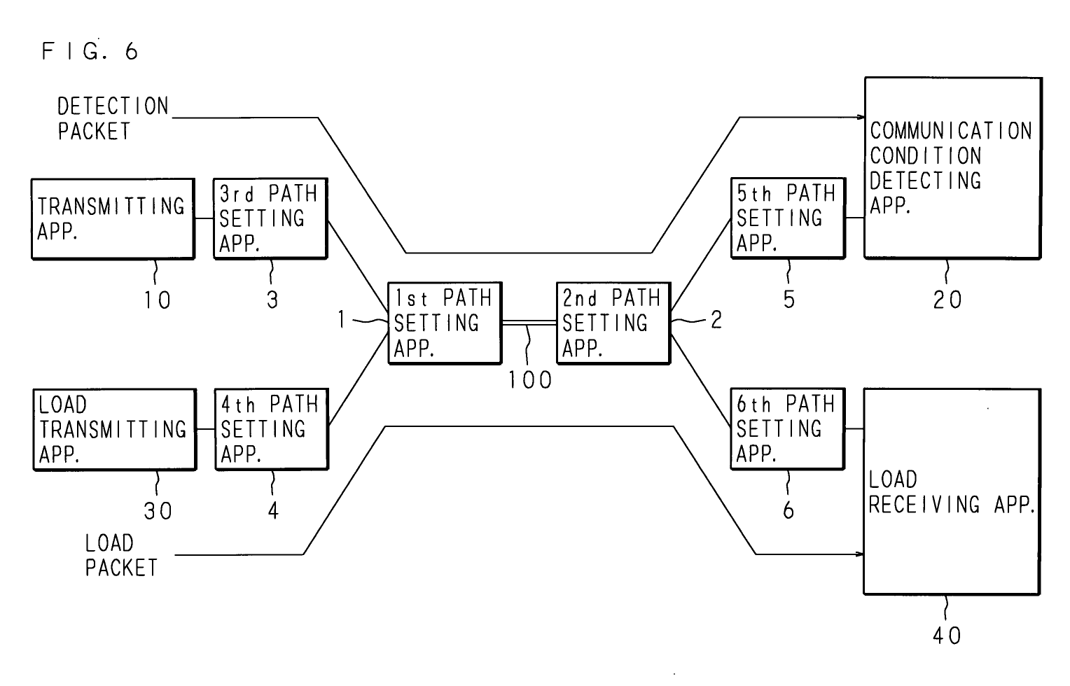

FIG. 6 is a schematic diagram conceptually showing the configuration of a communication condition detecting system according to Embodiment 2 of the present invention.

In Embodiment 2, a transmitting apparatus 10 is connected to a first path setting apparatus 1 through a third path setting apparatus 3 such as a router. In FIG. 6, reference numeral 30 denotes a load transmitting apparatus which uses a communication computer for transmitting packets. The load transmitting apparatus 30 is connected to the first path setting apparatus 1 through a fourth path setting apparatus 4 such as a router. Furthermore, a communication condition detecting apparatus 20 is connected to a second path setting apparatus 2 through a fifth path setting apparatus 5 such as a router. In FIG. 6, reference numeral 40 denotes a load receiving apparatus which uses a communication computer for receiving packets. The load receiving apparatus 40 is connected to the second path setting apparatus 2 through a sixth path setting apparatus 6 such as a router.

In Embodiment 2, the transmitting apparatus 10 periodically transmits a detection packet to which the communication condition detecting apparatus 20 is specified as a destination. The detection packet is transmitted to the first path setting apparatus 1 from the third path setting apparatus 3, passes through a communication path 100, and reaches the communication condition detecting apparatus 20 through the fifth path setting apparatus 5 from the second path setting apparatus 2. The load transmitting apparatus 30 transmits a load packet to which the load receiving apparatus 40 is specified as a destination. The load packet is transmitted to the first path setting apparatus 1 from the fourth path setting apparatus 4, passes through the communication path 100, and reaches the load receiving apparatus 40 through the sixth path setting apparatus 6 from the second path setting apparatus 2. Thus, the communication path 100 transmits the detection packet which is periodically transmitted from the transmitting apparatus 10 and the load packet which is transmitted from the load transmitting apparatus 30.

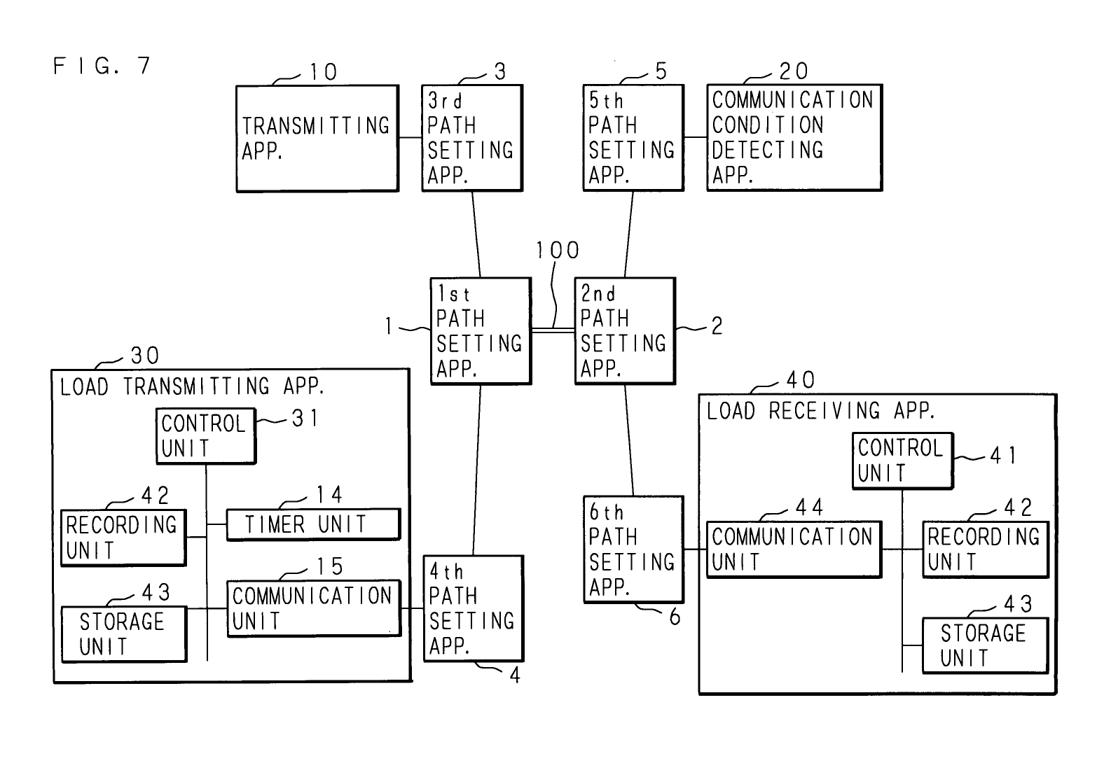

FIG. 7 is a block diagram showing the configuration of various apparatuses used in the communication condition detecting system according to Embodiment 2 of the present invention.

The load transmitting apparatus 30 includes a control unit 31, a recording unit 32, a storage unit 33, a timer unit 34, and a communication unit 35. The recording unit 32 and/or the storage unit 33 records and/or stores therein various data necessary to transmit a transmit packet and the load packet, such as an IP address (port number) of the load receiving apparatus 40 which is specified as the destination of the packet, a setting value for setting the attribute of the packet, the transmission period of the packet, and the number of transmissions of packet.

The load receiving apparatus 40 includes a control unit 41, a recording unit 42, a storage unit 43, and a communication unit 44.

Other configuration and functions of the apparatus than those described above are the same as those described in Embodiment 1; thus, Embodiment 1 is referred to and the description thereof is omitted.

The above Embodiment 2 describes the configuration in which the functions of the transmitting apparatus according to Embodiment 1 are separated into a transmitting apparatus and a load transmitting apparatus and the functions of the communication condition detecting apparatus are separated into a communication condition detecting apparatus and a load receiving apparatus. However, the present invention is not limited to such a configuration and can be developed into various configurations, e.g., a configuration in which only the transmitting apparatus side is separated or a configuration in which only the communication condition detecting apparatus side is separated.

### Embodiment 3

Embodiment 3 provides a configuration in which in Embodiment 2 a detection packet and a load packet are transmitted from a transmitting apparatus. Note that in the following description the components identical to those in Embodiment 2 are denoted by the same reference numerals as those used for Embodiment 2 and the description thereof is omitted.

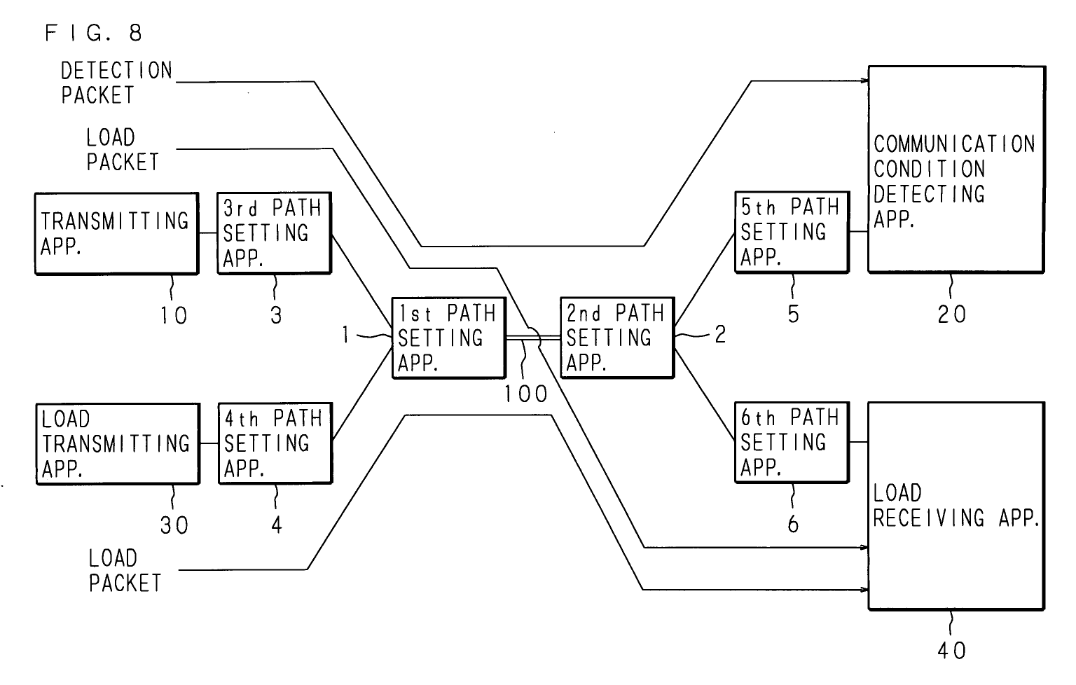

FIG. 8 is a schematic diagram conceptually showing the configuration of a communication condition detecting system according to Embodiment 3 of the present invention.

In Embodiment 3, a transmitting apparatus 10 transmits a detection packet with a predetermined transmission period, as with Embodiment 1, and transmits a load packet with a longer transmission period than the transmission period of the detection packet. A load transmitting apparatus 30 transmits a load packet as with Embodiment 2.

The transmission timing of the load packet from the transmitting apparatus 10 is synchronized to the transmission timing of the load packet from the load transmitting apparatus 30. For example, by transmitting a 10-Mbps load packet from each of the transmitting apparatus 10 and the load transmitting apparatus 30, a traffic load of 20 Mbps can be applied to a communication path 100. Furthermore, by increasing the number of the load transmitting apparatuses 30, for example, by using nine load transmitting apparatuses 30, and transmitting a 10-Mbps load packet from each of the transmitting apparatus 10 and the load transmitting apparatuses 30, a traffic load of 100 Mbps can be applied to the communication path 100. By thus transmitting the load packet from a plurality of apparatuses, a large traffic load can be applied to the communication path 100 without increasing a processing load on each apparatus or increasing a traffic load on each path from each apparatus to a first path setting apparatus 1.

Other configuration and functions of the apparatus than those described above are the same as those described in Embodiment 2; thus, Embodiment 2 is referred to and the description thereof is omitted.

The above Embodiment 3 describes the configuration in which the load packets of the same size are transmitted from each of transmitting apparatus and load transmitting apparatuses. However, the present invention is not limited to such a configuration and can be developed into various configurations, e.g., a configuration in which the load packets of arbitrary size are transmitted from the apparatuses. When a plurality of load transmitting apparatuses is used, the present invention may be developed into a configuration in which the transmitting apparatus transmits only the detection packet, i.e., a configuration in which a plurality of load transmitting apparatuses is used in Embodiment 2.

### Embodiment 4

Embodiment 4 provides a configuration in which in Embodiment 2 a plurality of load transmitting apparatuses 30 are used and load packets are transmitted from the load transmitting apparatuses 30, respectively, with different transmission periods. Note that in the following description the components identical to those in Embodiment 2 are denoted by the same reference numerals as those used for Embodiment 2 and the description thereof is omitted.

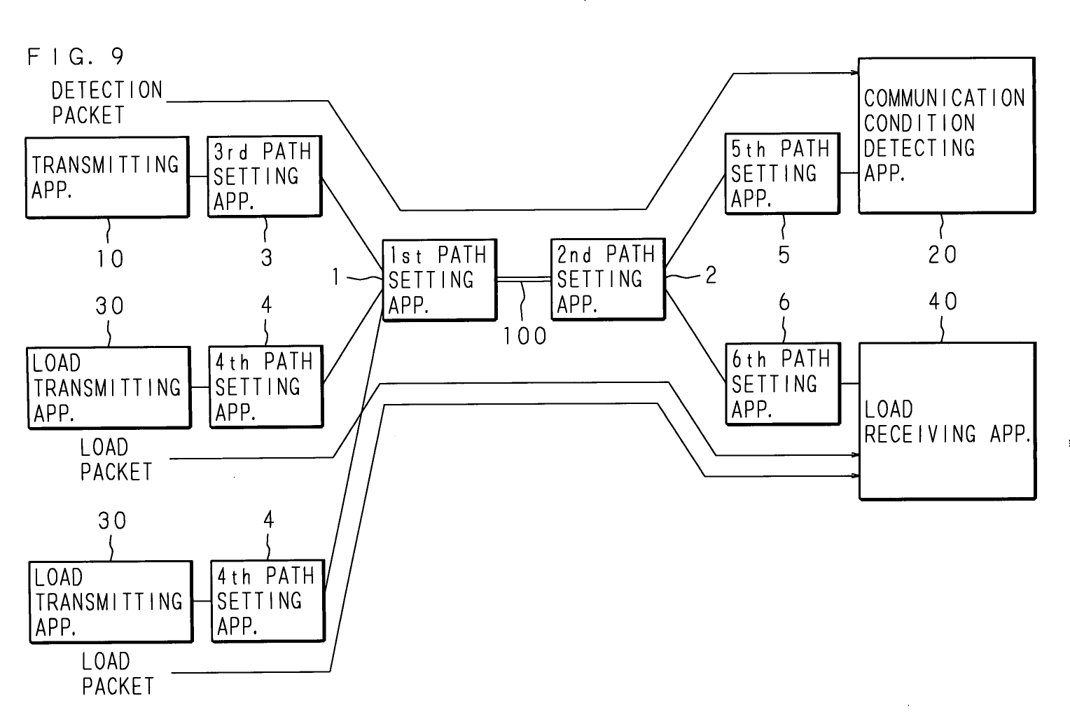

FIG. 9 is a schematic diagram conceptually showing the configuration of a communication condition detecting system according to Embodiment 4 of the present invention.

In Embodiment 4, two load transmitting apparatuses 30 are provided and the load packets are transmitted from the two load transmitting apparatuses 30, respectively, with different transmission periods. By transmitting load packets from the two load transmitting apparatuses 30 with different transmission periods, a traffic load that fluctuates with a period based on the product of the transmission periods and the difference between the transmission periods can be applied to a communication path 100. Note that a fluctuation period TO is Least Common Multiple of T1 and T2 which uses transmission periods T1 and T2 of the load packets transmitted from the two load transmitting apparatuses 30.

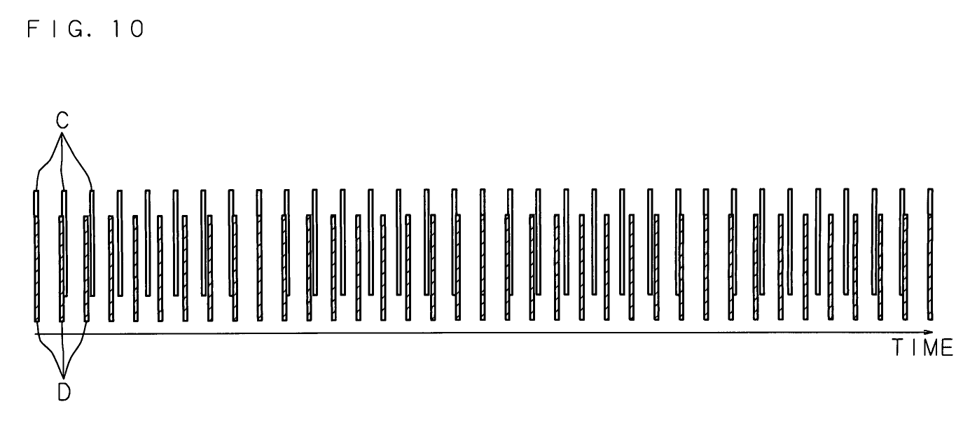

FIG. 10 is a schematic diagram conceptually showing the change in time of the packets passing through the communication path 100 in the communication condition detecting system according to Embodiment 4 of the present invention.

In FIG. 10, reference symbol C denotes the load packet transmitted with a first transmission period. In FIG. 10, reference symbol D denotes the load packet transmitted with a second transmission period which is different from the first transmission period. As shown in FIG. 10, by transmitting the load packets with different transmission periods, density and sparseness can be provided in transmission intervals of the load packets.

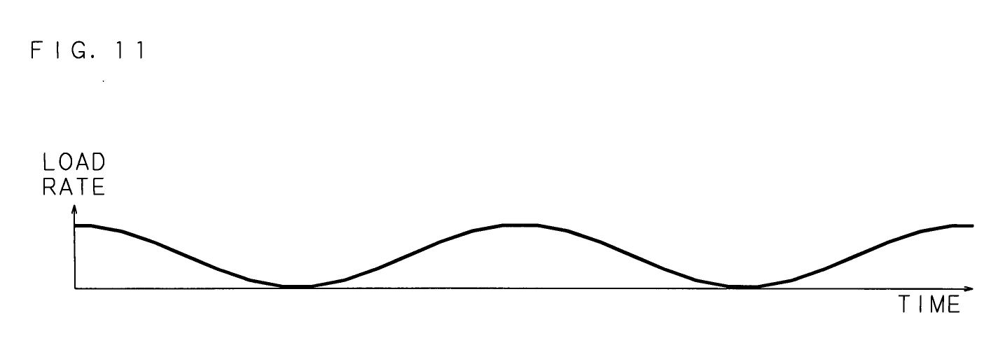

FIG. 11 is a schematic diagram conceptually showing the change in time of the traffic load on the communication path 100 in the communication condition detecting system according to Embodiment 4 of the present invention.

In FIG. 11, the time and the traffic load are taken on a horizontal axis and a vertical axis, respectively, whereby the relationship therebetween is shown. Specifically, FIG. 11 shows the change in time of a traffic load that is generated when the load packets with different periods such as those shown in FIG. 10 are transmitted to the communication path 100. In FIG. 11, a traffic load that fluctuates with a period given by the aforementioned T0 is generated. By thus transmitting the load packets from two load transmitting apparatuses 30 with different transmission periods, a traffic load that changes in time can be applied to the communication path 100 without the need to change a program for transmitting a load packet.

Other configuration and functions of the apparatus than those described above are the same as those described in Embodiment 2; thus, Embodiment 2 is referred to and the description thereof is omitted.

The above Embodiment 4 describes the configuration in which the load packets are transmitted from two load transmitting apparatuses. However, the present invention is not limited to such a configuration and can be developed into various configurations, e.g., a configuration in which the load packets are transmitted from three or more load transmitting apparatuses or a configuration in which one of apparatuses that transmit the load packets is configured to be a transmitting apparatus.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A method for detecting communication condition of a communication path set in a packet network, comprising the steps of:
periodically transmitting from a transmitting apparatus to said communication path a detection packet used to detect a communication condition;
transmitting from a transmitting apparatus to said communication path a load packet applying a traffic load to said communication path; and
detecting, by a communication condition detecting apparatus, a communication condition of said communication path based on a time and loss condition related to the detection packet having passed through said communication path.

2. A communication condition detecting system for detecting, by a communication condition detecting apparatus, a communication condition of a communication path set in a packet network, including:
a transmitting apparatus comprising: first transmitting means for periodically transmitting to said communication path a detection packet used to detect a communication condition; and second transmitting means for transmitting to said communication path a load packet for applying a traffic load to said communication path;
wherein said communication condition detecting apparatus detects a communication condition of said communication path based on a time and loss condition related to the detection packet having passed through said communication path.

3. The communication condition detecting system as set forth in claim 2, wherein said second transmitting means transmits to said communication path, as a group of the load packets, a plurality of packets which are successively transmitted.

4. The communication condition detecting system as set forth in claim 3, further including a load transmitting apparatus for transmitting a load packet to said communication path.

5. The communication condition detecting system as set forth in claim 4, wherein said transmitting apparatus and said load transmitting apparatus make transmission timings of the load packets to said communication path be synchronized to each other.

6. The communication condition detecting system as set forth in claim 4, wherein said transmitting apparatus and said load transmitting apparatus transmit to said communication path the load packets with different periods.

7. The communication condition detecting system as set forth in claim 2, wherein said second transmitting means transmits to said communication path the load packet a plurality of times at a longer time interval than a transmission period of the detection packet transmitted from said first transmitting means.

8. The communication condition detecting system as set forth in claim 7, further including a load transmitting apparatus for transmitting a load packet to said communication path.

9. The communication condition detecting system as set forth in claim 8, wherein said transmitting apparatus and said load transmitting apparatus make transmission timings of the load packets to said communication path be synchronized to each other.

10. The communication condition detecting system as set forth in claim 8, wherein said transmitting apparatus and said load transmitting apparatus transmit to said communication path the load packets with different periods.

11. A communication condition detecting system for detecting, by a communication condition detecting apparatus, a communication condition of a communication path set in a packet network, including:
a transmitting apparatus for periodically transmitting a detection packet to said communication path; and
a load transmitting apparatus for transmitting a load packet to said communication path;
wherein said communication condition detecting apparatus detects a communication condition of said communication path based on a time and loss condition related to the detection packet having passed through said communication path.

12. A communication condition detecting apparatus for detecting a communication condition of a communication path set in a packet network, wherein
a transmitting apparatus periodically transmits a detection packet used to detect a communication condition, and transmits a load packet for applying a traffic load to said communication path is connected to said communication path, and
a communication condition of said communication path is detected based on a time and loss condition related to the detection packet having passed through said communication path.

13. The communication condition detecting apparatus as set forth in claim 12, wherein said transmitting apparatus transmits to said communication path, as a group of the load packets, a plurality of packets which are successively transmitted.

14. The communication condition detecting apparatus as set forth in claim 13, wherein a load transmitting apparatus for transmitting the load packet to said communication path is further connected to said communication path.

15. The communication condition detecting apparatus as set forth in claim 14, wherein said transmitting apparatus and said load transmitting apparatus make transmission timings of the load packets to said communication path be synchronized to each other.

16. The communication condition detecting apparatus as set forth in claim 14, wherein said transmitting apparatus and said load transmitting apparatus transmit to said communication path the load packets with different periods.

17. The communication condition detecting apparatus as set forth in claim 12, wherein said transmitting apparatus transmits to said communication path the load packet a plurality of times at a longer time interval than a transmission period of the detection packet.

18. The communication condition detecting apparatus as set forth in claims 17, wherein a load transmitting apparatus for transmitting the load packet to said communication path is further connected to said communication path.

19. The communication condition detecting apparatus as set forth in claim 18, wherein said transmitting apparatus and said load transmitting apparatus make transmission timings of the load packets to said communication path be synchronized to each other.

20. The communication condition detecting apparatus as set forth in claim 18, wherein said transmitting apparatus and said load transmitting apparatus transmit to said communication path the load packets with different periods.
